(19) United States
(12) Patent Application Publication
(10) Pub. No.: US 2014/0006331 A1
(43) Pub. Date: Jan. 2, 2014

(54) POWER PREDICTION FOR NEWLY ADDED WIND TURBINE

(71) Applicant: International Business Machines Corporation, Armonk, NY (US)

(72) Inventors: Xinxin Bai, Beijing (CN); Jin Dong, Beijing (CN); Rui X. Guang, Beijing (CN); Haifeng Wang, Beijing (CN); Wen J. Yin, Beijing (CN)

(73) Assignee: International Business Machines Corporation, Armonk, NY (US)

(21) Appl. No.: 13/893,383

(22) Filed: May 14, 2013

(30) Foreign Application Priority Data
Jun. 29, 2012 (CN) 201210226659.X

(51) Int. Cl. G06N 5/02

(52) U.S. Cl. CPC G06N 5/02
USPC 706/46

(57) ABSTRACT

A method for predicting the power of a target wind turbine newly added in a wind farm. The method including determining a reference wind turbine associated with the target wind turbine; determining a power curve mapping relationship between the reference wind turbine and the target wind turbine according to a power curve of the reference wind turbine and a power curve of the target wind turbine; obtaining a power data distribution mapping relationship between the reference wind turbine and the target wind turbine according to wind speed historical data of the reference wind turbine and wind speed historical data of the target wind turbine; and estimating the power of the target wind turbine according to the power curve mapping relationship, the power data distribution mapping relationship, as well as the power and wind speed of the reference wind turbine.

The present application claims the benefit of priority of Chinese Patent Application Serial Number 201210226659.X, entitled “POWER PREDICTION FOR NEWLY ADDED WIND TURBINE”, filed Jun. 29, 2012 with the State Intellectual Property Office (SIPO) of the People's Republic of China, the contents of which are incorporated by reference herein in its entirety.

### TECHNICAL FIELD

The present invention relates to the field of wind turbine power generation, and more specifically, to a method and system for predicting the power of a newly added wind turbine.

### BACKGROUND

The wind power generation is one of green clean energies having a broad prospect of international application at present, and new energies such as wind power are strongly developed by lots of nations. The wind-generated power has natures of intermittence, randomness, anti-peaking, etc., and it is affected by many factors. The wind power prediction can effectively improve the quality of new energy power generation and the power network's capacity of accepting new energies. The accurate wind power prediction is one of key techniques for implementation of connecting reproducible energies to the power grid. How to reduce errors in key links of the wind power prediction, improve the accuracy of prediction and advance the controllability of the wind power generation are the technical challenges faced by wind power operating companies and the power network corporations collectively.

Wind power prediction methods are mainly classified as the short-term (48 hours in the future) and the ultra-short-term (4 hours in the future) predictions in terms of the prediction temporal scale. The short-term prediction is mainly used for a power dispatch section to make the next day's power generation plan, while the ultra-short-term prediction is mainly used for the automatic control of a wind farm, for example, the power brownout control and so on.

Methods for the ultra-short-term wind power prediction are mainly wind farm power prediction based on historical data, that is, it establishes a mapping relationship between several pieces of historical data (e.g. power) and the power output of a wind turbine. The existing methods include: Kalman filter method, Persistent algorithm, ARMA algorithm, Linear regression model, Adaptive fuzzy logic algorithm and so on. Additionally, data mining methods such as Artificial neural network method may be employed.

However, these methods cannot perform the ultra-short-term power prediction directly on a newly added wind turbine, because the newly added wind turbine, due to having not generated power yet or the time of generating power being short, has not historical data or has not sufficient historical data for the ultra-short-term prediction methods to establish the relationship between the historical data and the wind turbine's output power.

### SUMMARY OF THE INVENTION

According to one embodiment of the present invention, there is provided a method for predicting the power of a target wind turbine newly added in a wind farm, comprising: determining a reference wind turbine associated with the target wind turbine; determining a power curve mapping relationship between the reference wind turbine and the target wind turbine according to a power curve of the reference wind turbine and a power curve of the target wind turbine; obtaining a power data distribution mapping relationship between the reference wind turbine and the target wind turbine according to the wind speed historical data of the reference wind turbine and the wind speed historical data of the target wind turbine; and estimating the power of the target wind turbine according to the power curve mapping relationship, the power data distribution mapping relationship, as well as the power and wind speed of the reference wind turbine.

According to another embodiment of the present invention, there is provided a system for predicting the power of a target wind turbine newly added in a wind farm, comprising: a reference wind turbine determination unit configured to determine a reference wind turbine associated with the target wind turbine; a power curve mapping unit configured to determine a power curve mapping relationship between the reference wind turbine and the target wind turbine according to a power curve of the reference wind turbine and a power curve of the target wind turbine; a power data distribution mapping unit configured to obtain the power data distribution mapping relationship between the reference wind turbine and the target wind turbine according to the wind speed historical data of the reference wind turbine and the wind speed historical data of the target wind turbine; and a wind turbine power estimation unit configured to estimate the power of the target wind turbine according to the power curve mapping relationship, the power data distribution mapping relationship, as well as the power and wind speed of the reference wind turbine.

With the above solutions of the present invention, it is possible to more effectively use the historical data of the reference wind turbine associated with the newly added wind turbine to perform the ultra-short-term power prediction on the newly added wind turbine.

### BRIEF DESCRIPTION OF THE DRAWINGS

Through the more detailed description of exemplary embodiments of the present disclosure in combination with the accompanying drawings, the above and other objects, features and advantages of the present disclosure will become more apparent, wherein the same reference generally refers to the same components in the exemplary embodiments of the present disclosure.

FIG. 1 shows a block diagram of an exemplary computer system 100 which is applicable to implement the embodiments of the present invention.

FIG. 2 shows a flow chart of a method for predicting the power of a newly added target wind turbine according to one embodiment of the present invention.

FIG. 3 shows a flow chart of a method for predicting the power of a newly added target wind turbine according to another embodiment of the present invention.

FIG. 4 shows a block diagram of a system for predicting the power of a newly added target wind turbine according to one embodiment of the present invention.

### DETAILED DESCRIPTION OF EMBODIMENTS

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

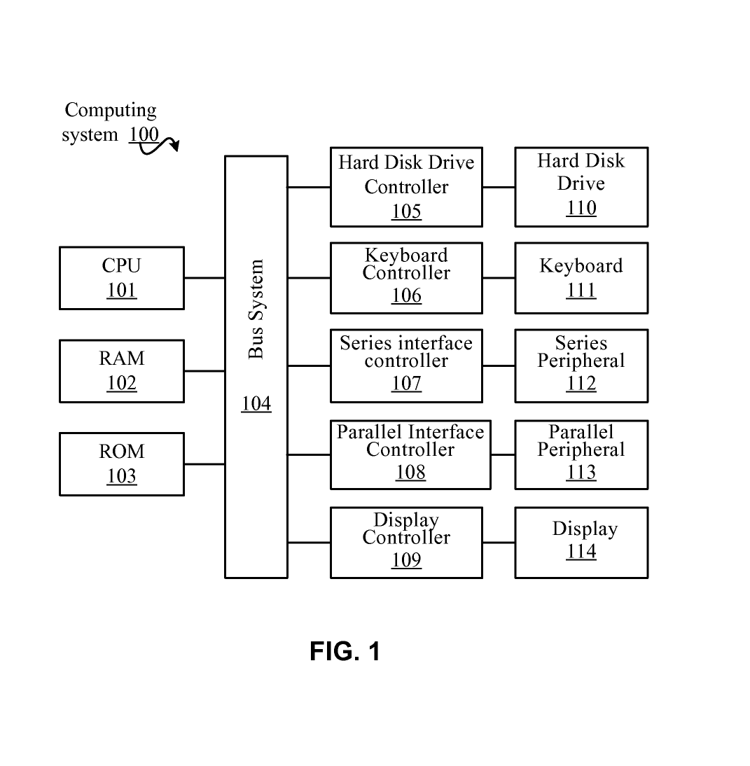

FIG. 1 shows a block diagram of an exemplary computer system 100 which is applicable to implement the embodiments of the present invention. As shown in FIG. 1, the computer system 100 may include: CPU (Central Process Unit) 101, RAM (Random Access Memory) 102, ROM (Read Only Memory) 103, System Bus 104, Hard Drive Controller 105, Keyboard Controller 106, Serial Interface Controller 107, Parallel Interface Controller 108, Display Controller 109, Hard Drive 110, Keyboard 111, Serial Peripheral Equipment 112, Parallel Peripheral Equipment 113 and Display 114. Among above devices, CPU 101, RAM 102, ROM 103, Hard Drive Controller 105, Keyboard Controller 106, Serial Interface Controller 107, Parallel Interface Controller 108 and Display Controller 109 are coupled to the System Bus 104. Hard Drive 110 is coupled to Hard Drive Controller 105. Keyboard 111 is coupled to Keyboard Controller 106. Serial Peripheral Equipment 112 is coupled to Serial Interface Controller 107. Parallel Peripheral Equipment 113 is coupled to Parallel Interface Controller 108. And, Display 114 is coupled to Display Controller 109. It should be understood that the structure as shown in FIG. 1 is only for the exemplary purpose rather than any limitation to the present invention. In some cases, some devices may be added to or removed from the computer system 100 based on specific situations.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, in some embodiments, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the users computer, partly on the users computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instruction means which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As already mentioned in the above, a newly added wind turbine, due to having not generated power yet or the time of generating power being short, has not historical data or has not sufficient historical data for an ultra-short-term prediction method to establish the relationship between the historical data and the wind turbine's output power. Therefore, many prediction methods in the prior art cannot be used to perform the ultra-short-term power prediction directly on the newly added wind turbine. At this time, it is required to use the historical data of other wind turbines to perform the prediction. However, the different wind turbines have different power generation rules due to their difference in factors such as locations, addresses, machine types, wind turbine machinery, etc, the data of other wind turbines can not be directly used as the historical data of the newly added wind turbine. The present invention thus provides a novel method to effectively use the historical data of other wind turbines to predict the power of a newly added wind turbine.

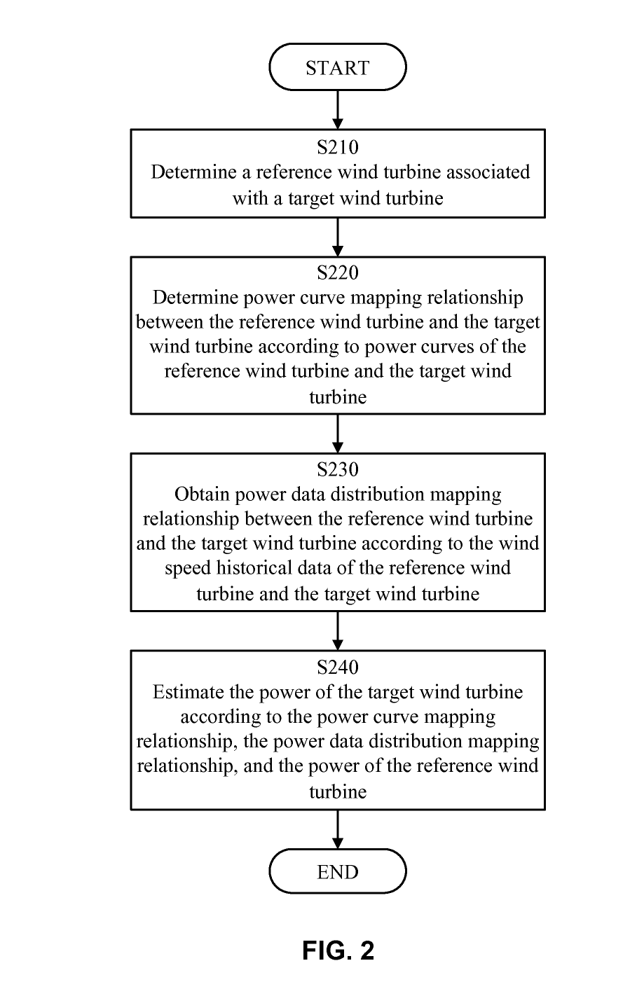

In the following, a method for predicting the power of a newly added target wind turbine according to an embodiment of the present invention will be described with reference to FIG. 2.

First, at step S210, a reference wind turbine associated with the target wind turbine is determined. The target wind turbine is a wind turbine newly added in a wind farm. The reference wind turbine is determined in order to find a wind turbine having a similar wind environment with the target wind turbine. Due to the particularity of the wind power generation, on one hand, a wind farm is usually built by several stages. In this way, in the same wind farm, a wind turbine constructed in a previous stage which has a similar wind environment with the target wind turbine may function as a reference wind turbine associated with the target wind turbine. Alternatively, the construction of wind farms is generally concentrated, and the wind environments in neighbor wind farms are similar, thus, it is also possible to consider a wind turbine in a neighbor wind farm as a reference wind turbine. At the step, the most associated reference wind turbine may be selected, or multiple reference wind turbines may be selected simultaneously.

At step S220, the power curve mapping relationship between the reference wind turbine and the target wind turbine is determined according to power curves of the reference wind turbine and the target wind turbine.

The power curve of a wind turbine indicates the inherent wind-speed-to-power relationship of the wind turbine, and it is generally a curve with two dimensional coordinates with the vertical axis being the power (e.g. kw/h (kilowatt per hour)) and the horizontal axis being the wind speed (e.g. m/s (meter per second)). Usually, the full power generation state will be achieved after the rated wind speed is reached, and the output power at this time is a straight line.

For different wind turbines, the power curves, i.e. the wind-speed-to-power correspondence, thereof are likely to be different. In such a case, in order to utilize the historical data of the reference wind turbine to estimate the power of the target wind turbine, firstly, the power curves of the reference wind turbine and the target wind turbine are obtained, and then, the power curve mapping relationship between the reference wind turbine and the target wind turbine is determined, that is, the ratio fₜₛ(w) of the generated powers of the target wind turbine and that of the reference wind turbine in different wind speed cases, where w indicates a value of the wind speed. Specifically, for a certain wind speed w, the generated powers Xs, Xt of the target wind turbine and the reference wind turbine are searched for respectively according to the power curves, and through the ratio of the powers Xs to Xt, the power curve mapping relationship can be obtained, i.e. fₜₛ(w)=Xs/Xt.

At step S230, the power data distribution mapping relationship between the reference wind turbine and the target wind turbine is obtained according to the wind speed historical data of the reference wind turbine and the wind speed historical data of the target wind turbine.

Due to the inherent wind-speed-to-power correspondence of a wind turbine, according to the historical data distribution cases of the wind speeds of the reference wind turbine and the target wind turbine, the mapping of the power data distribution of the reference wind turbine and the target wind turbine may be obtained. Wherein, the wind speed historical data distribution of a wind turbine may be obtained from wind tower.

The wind tower is a tower-shaped building located in the site of a wind farm, and it is capable of observing and recording the near-ground air motion, and it may observe the wind of the farm site incessantly in a round-the-clock manner with the observation data being recorded and stored in a data recorder mounted on the tower body. The wind tower is generally used for collecting data of the wind power resource at the wind farm in a previous stage. Thus, when a wind turbine is newly added at the wind farm, usually, the wind tower has accumulated a great lot of historical data about the wind power. At this time, it is possible to obtain the wind speed data distribution mapping between the reference wind turbine and the target wind turbine according to the wind speed historical data of the wind tower of the reference wind turbine and the wind speed historical data of the wind tower of the target wind turbine, so that the power data distribution mapping relationship is obtained accordingly.

At step S240, the power of the target wind turbine is estimated according to the power curve mapping relationship, the power data distribution mapping relationship between the reference wind turbine and the target wind turbine, as well as the power and wind speed of the reference wind turbine.

In this way, the power output of the target wind turbine may be estimated by using the historical data of the reference wind turbine.

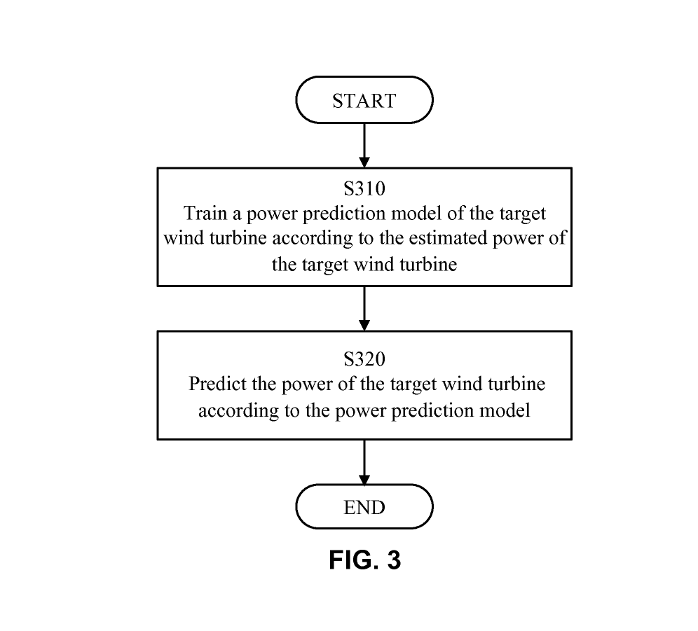

FIG. 3 shows a flow chart of a method for predicting the power of a newly added target wind turbine according to another embodiment of the present invention. The method may utilize the method as shown in FIG. 2 to estimate the power of the target wind turbine to further predict the ultra-short-term power of the target wind turbine.

At step S310, a power prediction model of the target wind turbine is trained according to the estimated power of the target wind turbine. At this time, the estimated power of the target wind turbine is taken as the historical data of the target wind turbine, and the power prediction model of the target wind turbine is trained by employing any model training method as known by those skilled in the art, for example methods such as Kalman filter method, Persistent algorithm, ARMA algorithm, Linear regression model, Adaptive fuzzy logic algorithm and so on. All of these methods are existing model training methods, thus, the details thereof will not be described.

Further, according to one embodiment of the present invention, the power prediction model of the target wind turbine is trained by using the data of multiple different reference wind turbines. That is to say, for the data of each reference wind turbine, the power prediction model is trained according to the estimated power of the corresponding target wind turbine, and respective obtained power prediction models are used for power prediction in combination. Specifically, the historical power of the target wind turbine is estimated for each reference wind turbine, and several eigenvectors for prediction Fᵢ=( . . . , X_{i-2T}, X_{i-T}) are created for each group of estimated historical data of the target wind turbine, where i indicates a certain historical timing, T indicates the time interval of the power, and X represents the power at the timing. Using the eigenvector F, the model training may be performed according to an existing ultra-short-term prediction method. All of the obtained power prediction models will be used for power prediction in a manner of linear combination.

At step S320, the power of the target wind turbine is predicted according to the power prediction model.

According to one embodiment of the present invention, in this prediction step, in a case that there are multiple power prediction models, the prediction feature F for prediction may be produced at first; then, the prediction power Yk corresponding to the prediction feature is produced according to each of the trained power prediction models k; and the produced prediction power Yk are combined to determine the final prediction power Y of the target wind turbine.

For example, several eigenvectors Fᵢ=( . . . , X_{i-2T}, X_{i-T}) for prediction are created for the real-time data of the target wind turbine in consistent with the model training, where i indicates a certain historical timing, and T indicates the time interval of the power. For each trained power prediction model, the power Yk is predicted according to the model k, where k=1 . . . K. K is the number of the prediction models. Accordingly, the final prediction power of the target wind turbine may be as follows:

$$Y = \frac{1}{K} {{å}^{K}}_{k = 1} {Y}_{k}$$

In the above formula, the final prediction power is the mean value of multiple Yks. However, it should be understood by those skilled in the art that this formula is just for the exemplary purpose, and the final prediction power may also be obtained by employing other manners. For example, the final prediction power may also be obtained by weighted-averaging or combining in other manners the output power Yk of different prediction models k respectively.

The step of determining the reference wind turbine associated with the target wind turbine may be implemented by using a variety of different manners. For example, those skilled may directly designate which wind turbines may be a reference wind turbine, or the determination may be made according to any parameter of the position, landform, wind speed data distribution, etc of a wind turbine or the combination thereof.

For example, according to one embodiment of the present invention, the positions of the target wind turbine and the reference wind turbine are set as Lt (xLt, yLt, zLt), Ls (xLs, yLs, zLt) respectively, where x, y, z are the coordinates of the positions Lt, Ls respectively. Thus, the position similarity between the target wind turbine and the reference wind turbine may be expressed by the following formula:

M_{L}=1/[(zLt−zLs)²+(zLt−zLs)²+(zLt−zLs)]^{1/2}

The higher the position similarity is, the more associated the reference wind turbine may be with the target wind turbine. The reference wind turbine associated with the target wind turbine may be determined by setting the value of the position similarity no less than a particular threshold or by finding several wind turbines having higher position similarities.

For example again, according to one embodiment of the present invention, the rectangular landforms surrounding the target wind turbine and the reference wind turbine by N km are set as Dt, Ds respectively, where D is a M*M matrix. D(p, q) indicates the altitude of the position corresponding to the element on the p-th row and the q-th column. The landform similarity between the target wind turbine and the reference wind turbine is as follows:

$${M}_{D} = 1 / {\sum }_{p = 1}^{M} {\sum }_{q = 1}^{M} \sqrt{{[ Dt ( p , q ) - Ds ( p , q ) ]}^{2}}$$

The higher the landform similarity is, the more associated the reference wind turbine may be with the target wind turbine. The reference wind turbine associated with the target wind turbine may be determined by setting the value of the landform similarity no less than a particular threshold or by finding several wind turbines having higher landform similarities.

For example again, according to one embodiment of the present invention, the historical wind speed data Tt, Ts of the target wind turbine and the reference wind turbine are set, where T is a vector with length of K. The history similarity between the target wind turbine and the reference wind turbine is as follows:

$${M}_{T} = 1 / {\sum }_{k = 1}^{K} \sqrt{{( Tt ( k ) - Ts ( k ) )}^{2}}$$

The higher the history similarity is, the more associated the reference wind turbine may be with the target wind turbine. The reference wind turbine associated with the target wind turbine may be determined by setting the value of the history similarity no less than a particular threshold or by finding several wind turbines having higher history similarities.

Alternatively, the above position similarity, landform similarity and history similarity may also be combined to determine the reference wind turbine. For example, the total similarity between the target wind turbine and the reference wind turbine is M=a*M_{L}+b*M_{D}+c*M_{T}, where a, b, c are weights of the similarities. Finally, several wind turbines having higher total similarities are selected as the reference wind turbines.

It can be understood by those skilled in the art that the determination of the reference wind turbine associated with the target wind turbine may be implemented by using any one of manners based on position, landform or historical wind speed data as described above, or it may be implemented by any combination of these manners, or it may be determined in a manner of artificial designation. Also, it can be understood by those skilled in the art that it may be determined by using any other manners capable of determining associated reference wind turbine rather than being limited to the particular manners as described here.

In the following, a specific implementation of the step of obtaining the power data distribution mapping relationship between the target wind turbine and the reference wind turbine will be further described according to one embodiment of the present invention.

Wherein, according to the wind speed historical data of the reference wind turbine and the wind speed historical data of the target wind turbine, the power data distribution mapping relationship between the reference wind turbine and the target wind turbine may be obtained by using the formula as follows:

β=P(Xs)/P(Xt)=[P(Ws)/P(Wt)]³*Tc

Wherein, β represents the power data distribution mapping relationship, Xt, Xs represent the powers of the target wind turbine and the reference wind turbine respectively, P(Xt), P(Xs) represent the power data distributions of the target wind turbine and the reference wind turbine respectively, Wt, Ws represent the wind speeds of the target wind turbine and the reference wind turbine respectively, P(Wt), P(Ws) represent the wind speed data distributions of the target wind turbine and the reference wind turbine respectively, and Tc is a constant.

Utilization of the data of the reference wind turbine requires knowing the power data distribution matching relationship β between the target wind turbine and the reference wind turbine. For a certain timing i, βi=P(Xsi)/P(Xti), where Xs, Xt are the generated powers of the target wind turbine and the reference wind turbine respectively. According to the relationship between the wind speed and the generated power X=ρπR²W³/2, where X is the output power of a wind turbine, ρ is the standard air density, R is the blade radius of the wind turbine, C is the wind energy conversion efficiency coefficient of the blades of a wind turbine, W is the wind speed, R and C are constants for a certain wind turbine,

β=P(Xs)/P(Xt)=[P(Ws)/P(Wt)]³*[Rs/Rt]²*[Cs/Ct]

Tc=[Rs/Rt]²*[Cs/Ct]

Wherein, Ws, Wt are the wind speeds of the wind towers of the target wind turbine and the reference wind turbine respectively, Rs, Rt are the blade radiuses of the target wind turbine and the reference wind turbine respectively, and Cs, Ct are the wind energy conversion efficiency coefficients of the blades of the target wind turbine and the reference wind turbine respectively.

Wherein, the ratio α=P(Ws)/P(Wt) needs to meet the condition as follows:

$${min}_{a} \frac{1}{2} {a}^{T} Ka - {k}^{T} a$$

Wherein, the superscript T indicates the transpose of a matrix. K is a kernel function matrix.

$$K = [ \begin{matrix}{K}_{tt} & {K}_{st} \\ {K}_{st}^{T} & {K}_{ss}\end{matrix} ] .$$

The value of the element on the i-th row and the j-th column of Ktt is k(wₜ(i),wₜ(j)), the value of the element on the i-th row and the j-th column of Kst is k(wₛ(i),wₜ(j)), and the value of the element on the i-th row and the j-th column of Kss is k(wₛ(i),wₛ(j)). k(wi,wj) is a kernel function, and it indicates the inner-product of wi and wj. For example, when the kernel function is a linear kernel function,

k(wi,wj)=λwiwj, where λ is a constant.

Other common kernel functions further include polynomial kernel function, radial basis kernel function, Sigmoid kernel function and complex kernel function. k is a column vector summed per row of K.

In addition, according to one embodiment of the present invention, the step of estimating the power of the target wind turbine according to the power curve mapping relationship, the power data distribution mapping relationship as well as the power and wind speed of the reference wind turbine may use the following formula to obtain the power of the target wind turbine:

Xti=Xsi*fts(Wsi)*β(Wsi)

Wherein, Xti, Xsi represent the powers of the target wind turbine and the reference wind turbine at a certain timing i respectively, Wsi represents the wind speed of the reference wind turbine at a certain timing i, fts(Wsi) represents the power curve mapping relationship when the wind speed of the reference wind turbine is Wsi, and β(Wsi) represents the power data distribution mapping relationship when the wind speed of the reference wind turbine is Wsi.

In this way, when provided with the wind speed of the reference wind turbine, it is possible to obtain the ratio of the generated powers of the target wind turbine to the reference wind turbine according to the power curve mapping relationship and the power data distribution mapping relationship, and to calculate the power of the target wind turbine according to the ratio of the power of the target wind turbine to the generated power of the reference wind turbine.

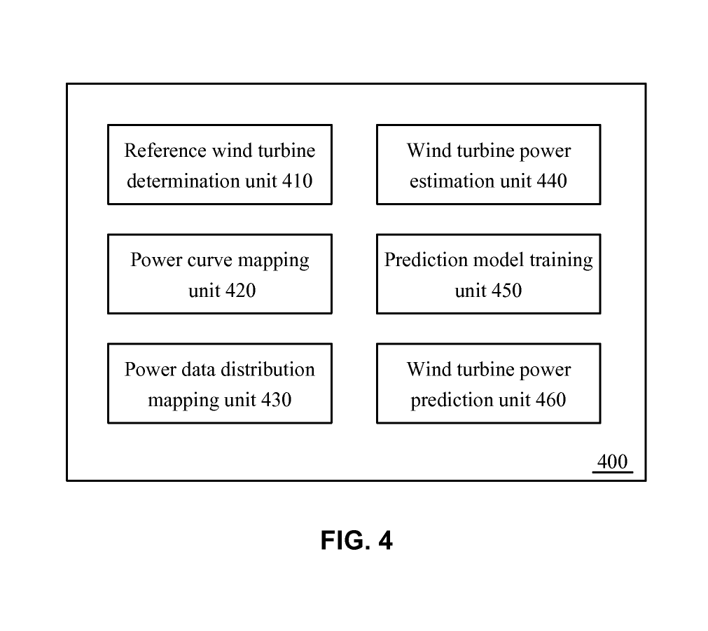

FIG. 4 shows a block diagram of a system for predicting the power of a newly added target wind turbine according to one embodiment of the present invention. The system 400 may include a reference wind turbine determination unit 410, a power curve mapping unit 420, a power data distribution mapping unit 430 and a wind turbine power estimation unit 440. Wherein, the reference wind turbine determination unit is configured to determine a reference wind turbine associated with the target wind turbine, the power curve mapping unit is configured to determine the power curve mapping relationship between the reference wind turbine and the target wind turbine according to the power curves of the reference wind turbine and the target wind turbine, the power data distribution mapping unit is configured to obtain the power data distribution mapping relationship between the reference wind turbine and the target wind turbine according to the wind speed historical data of the reference wind turbine and the wind speed historical data of the target wind turbine, and the wind turbine power estimation unit is configured to estimate the power of the target wind turbine according to the power curve mapping relationship, the power data distribution mapping relationship, as well as the power and wind speed of the reference wind turbine.

According to one embodiment of the present invention, the system 400 may further include a prediction model training unit 450 which is configured to train the power prediction model of the target wind turbine according to the estimated power of the target wind turbine.

According to one embodiment of the present invention, the system 400 may further include a wind turbine power prediction unit 460 which is configured to predict the power of the target wind turbine according to the power prediction model of the target wind turbine.

According to one embodiment of the present invention, the reference wind turbine determination unit 410 is further configured to determine the reference wind turbine associated with the target wind turbine according to at least one parameter of the position, landform, and wind speed data distribution.

According to one embodiment of the present invention, the power curve mapping unit 420 is further configured to obtain the power curves of the reference wind turbine and the target wind turbine.

According to one embodiment of the present invention, the power data distribution mapping unit 430 is configured to obtain the power data distribution mapping relationship by using the formula as follows:

β=P(Xs)/P(Xt)=[P(Ws)/P(Wt)]³*Tc

Wherein, β represents the power data distribution mapping relationship, Xt, Xs represent the powers of the target wind turbine and the reference wind turbine respectively, P(Xt), P(Xs) represent the power data distributions of the target wind turbine and the reference wind turbine respectively, Wt, Ws represent the wind speeds of the target wind turbine and the reference wind turbine respectively, P(Wt), P(Ws) represent the wind speed data distributions of the target wind turbine and the reference wind turbine respectively, and Tc is a constant.

According to one embodiment of the present invention, the wind turbine power estimation unit 440 is configured to obtain the power of the target wind turbine by using the formula as follows:

Xti=Xsi*fts(Wsi)*β(Wsi)

Wherein, Xti, Xsi represent the powers of the target wind turbine and the reference wind turbine at a certain timing i respectively, Wsi represents the wind speed of the reference wind turbine at a certain timing i, fts(Wsi) represents the power curve mapping relationship when the wind speed of the reference wind turbine is Wsi, and β(Wsi) represents the power data distribution mapping relationship when the wind speed of the reference wind turbine is Wsi.

According to one embodiment of the present invention, the reference wind turbine determination unit 410 is further configured to determine multiple reference wind turbines associated with the target wind turbine, and the prediction model training unit 450 is further configured to train, for the data of each reference wind turbine, the power prediction model according to the estimated power of the target wind turbine.

According to one embodiment of the present invention, the wind turbine power prediction unit 460 is further configured to produce prediction features for prediction, produce the prediction powers corresponding to the prediction features according to respective trained power prediction models, and combine the produced prediction powers to determine the final prediction power of the target wind turbine.

According to one embodiment of the present invention, the method and system of the present invention may both be used for the ultra-short-term power prediction of a newly added wind turbine on a wind farm. However, it can be understood by those skilled in the art that the method and system of the present invention is not limited to the ultra-short-term power prediction, and, for example, it may also be used for the short-term power prediction of a newly added wind turbine on a wind farm solely or in conjunction with other methods.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or a portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for predicting the power of a target wind turbine newly added in a wind farm, the method comprising:
determining a reference wind turbine associated with the target wind turbine;
determining a power curve mapping relationship between the reference wind turbine and the target wind turbine according to a power curve of the reference wind turbine and a power curve of the target wind turbine;
obtaining a power data distribution mapping relationship between the reference wind turbine and the target wind turbine according to wind speed historical data of the reference wind turbine and wind speed historical data of the target wind turbine; and
estimating the power of the target wind turbine according to the power curve mapping relationship, the power data distribution mapping relationship, as well as the power and wind speed of the reference wind turbine.

2. The method according to claim 1, further comprising:
training a power prediction model of the target wind turbine according to the estimated power of the target wind turbine.

3. The method according to claim 1, further comprising:
predicting the power of the target wind turbine according to a power prediction model of the target wind turbine.

4. The method according to claim 1, wherein determining the reference wind turbine associated with the target wind turbine comprises:
determining the reference wind turbine associated with the target wind turbine according to at least one parameter of the position, landform, and wind speed data distribution.

5. The method according to claim 1, wherein determining the power curve mapping relationship between the reference wind turbine and the target wind turbine according to the power curve of the reference wind turbine and the power curve of the target wind turbine further comprises:
obtaining the power curves of the reference wind turbine and the target wind turbine.

6. The method according to claim 1, wherein obtaining the power data distribution mapping relationship between the reference wind turbine and the target wind turbine according to the wind speed historical data of the reference wind turbine and the wind speed historical data of the target wind turbine comprises:
obtaining the power data distribution mapping relationship by using the formula as follows:
β=P(Xs)/P(Xt)=[P(Ws)/P(Wt)]³*Tc
wherein, β represents the power data distribution mapping relationship, Xt, Xs represent the powers of the target wind turbine and the reference wind turbine respectively, P(Xt), P(Xs) represent the power data distributions of the target wind turbine and the reference wind turbine respectively, Wt, Ws represent the wind speeds of the target wind turbine and the reference wind turbine respectively, P(Wt), P(Ws) represent the wind speed data distributions of the target wind turbine and the reference wind turbine respectively, and Tc is a constant.

7. The method according to claim 1, wherein estimating the power of the target wind turbine according to the power curve mapping relationship, the power data distribution mapping relationship, as well as the power and wind speed of the reference wind turbine comprises:
obtaining the power of the target wind turbine by using the formula as follows:
Xti=Xsi*fts(Wsi)*β(Wsi)
wherein, Xti, Xsi represent the powers of the target wind turbine and the reference wind turbine at a certain timing i respectively, Wsi represents the wind speed of the reference wind turbine at a certain timing i, fts(Wsi) represents the power curve mapping relationship when the wind speed of the reference wind turbine is Wsi, and β(Wsi) represents the power data distribution mapping relationship when the wind speed of the reference wind turbine is Wsi.

8. The method according to claim 1, wherein determining the reference wind turbine associated with the target wind turbine comprises:
determining a plurality of reference wind turbines associated with the target wind turbine.

9. The method according to claim 3, wherein predicting the power of the target wind turbine according to the power prediction model of the target wind turbine comprises:
producing a prediction feature for prediction;
producing a prediction power corresponding to the prediction feature according to respective trained power prediction models; and
combining the produced prediction powers to determine the final prediction power of the target wind turbine.

10. The method according to claim 1, wherein, the method is used for the ultra-short-term prediction for a wind turbine's power.

11. A system for predicting the power of a target wind turbine newly added in a wind farm, the system comprising:
a reference wind turbine determination unit configured to determine a reference wind turbine associated with the target wind turbine;
a power curve mapping unit configured to determine a power curve mapping relationship between the reference wind turbine and the target wind turbine according to a power curve of the reference wind turbine and a power curve of the target wind turbine;
a power data distribution mapping unit configured to obtain the power data distribution mapping relationship between the reference wind turbine and the target wind turbine according to the wind speed historical data of the reference wind turbine and the wind speed historical data of the target wind turbine; and
a wind turbine power estimation unit configured to estimate the power of the target wind turbine according to the power curve mapping relationship, the power data distribution mapping relationship, as well as the power and wind speed of the reference wind turbine.

12. The system according to claim 11, further comprising:
a prediction model training unit configured to train a power prediction model of the target wind turbine according to the estimated power of the target wind turbine.

13. The system according to claim 11, further comprising:
a wind turbine power prediction unit configured to predict the power of the target wind turbine according to the power prediction model of the target wind turbine.

14. The system according to claim 11, wherein the reference wind turbine determination unit is further configured to determine the reference wind turbine associated with the target wind turbine according to at least one parameter of the position, landform, and wind speed data distribution.

15. The system according to claim 11, wherein the power curve mapping unit is further configured to obtain the power curves of the reference wind turbine and the target wind turbine.

16. The system according to claim 11, wherein the power data distribution mapping unit is configured to obtain the power data distribution mapping relationship by using the formula as follows:
β=P(Xs)/P(Xt)=[P(Ws)/P(Wt)]³*Tc
wherein, β represents the power data distribution mapping relationship, Xt, Xs represent the powers of the target wind turbine and the reference wind turbine respectively, P(Xt), P(Xs) represent the power data distributions of the target wind turbine and the reference wind turbine respectively, Wt, Ws represent the wind speeds of the target wind turbine and the reference wind turbine respectively, P(Wt), P(Ws) represent the wind speed data distributions of the target wind turbine and the reference wind turbine respectively, and Tc is a constant.

17. The system according to claim 11, wherein the wind turbine power estimation unit is configured to obtain the power of the target wind turbine by using the formula as follows:
Xti=Xsi*fts(Wsi)*β(Wsi)
wherein, Xti, Xsi represent the powers of the target wind turbine and the reference wind turbine at a certain timing i respectively, Wsi represents the wind speed of the reference wind turbine at a certain timing i, fts(Wsi) represents the power curve mapping relationship when the wind speed of the reference wind turbine is Wsi, and β(Wsi) represents the power data distribution mapping relationship when the wind speed of the reference wind turbine is Wsi.

18. The system according to claim 11, wherein the reference wind turbine determination unit is further configured to determine a plurality of reference wind turbines associated with the target wind turbine, and the prediction model training unit is further configured to train, for the data of each reference wind turbine, the power prediction model according to the estimated power of the target wind turbine.

19. The system according to claim 13, wherein, said wind turbine power prediction unit is further configured to:
produce a prediction feature for prediction;
produce a prediction power corresponding to the prediction feature according to respective trained power prediction models; and
combine the produced prediction powers to determine the final prediction power of the target wind turbine.

20. The system according to claim 11, wherein the system is used for the ultra-short-term prediction for a wind turbine's power.

21. The method according to claim 2, wherein training the power prediction model of the target wind turbine according to the estimated power of the target wind turbine comprises:
training the power prediction model according to the estimated power of the target wind turbine for the data of each reference wind turbine.
